(19) United States
(12) Patent Application Publication
(10) Pub. No.: US 2010/0037184 A1
(43) Pub. Date: Feb. 11, 2010

(54) PORTABLE ELECTRONIC DEVICE AND METHOD FOR SELECTING MENU ITEMS

(75) Inventor: Yun-Long Sie, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/332,353

(22) Filed: Dec. 11, 2008

(30) Foreign Application Priority Data
Aug. 8, 2008 (CN) 200810303610.3

(51) Int. Cl. G06F 3/033

(52) U.S. Cl. 715/863

(57) ABSTRACT

A portable electronic device includes a motion detection module and a storage system. The motion detection module is configured for determining a direction of movement of the portable electronic device when orientation of the portable electronic device has been changed. The motion detection module is further configured for generating an input signal associated with the movement and providing the input signal to an application of the portable electronic device to initiate an operation performed by the application, wherein the input signal includes menu position information of a menu item of the application. The motion detection module is further configured for selecting a desired menu item according to the menu position. The storage system is used for storing the application and movement data of the portable electronic device.

### BACKGROUND

1. Technical Field

Embodiments of the present disclosure relate to the field of input technology for portable electronic devices, and more particularly to a portable electronic device and a method for selecting menu items on the portable electronic device.

2. Description of Related Art

Portable electronic devices are increasingly being used in everyday life. As technological advancements are made, portable electronic devices are being made ever smaller and lighter while at the same time including more applications. The user interface of a portable electronic device, and more particularly, an input portion of the user interface, is very important to the operation and operability of the portable electronic device. Conventionally, user commands and data are input into portable electronic devices using devices such as a keyboard or keypad, a mouse, a joystick etc. For scrolling and menu navigation, arrow buttons, thumbwheels, etc. may also be included with the portable electronic devices.

However, as portable electronic devices become more sophisticated and smaller, traditional keypads, arrow buttons, etc. may become impractical or non-enjoyable if the component parts are too small. Accordingly, complex menus, three-dimensional maps, and advanced games requiring more sophisticated navigation exacerbate the problem.

Therefore, there is a demand for a portable electronic device and method for efficiently selecting menu items on the portable electronic device.

### BRIEF DESCRIPTION OF THE DRAWINGS

FIG. 1 is a block diagram of one embodiment of a portable electronic device.

FIG. 2 is a diagram illustrating a coordinate plane for rotating the portable electronic device of FIG. 1.

FIG. 3 is a diagram illustrating a relation of rotation direction and rotation acceleration while rotating the portable electronic device of FIG. 1.

FIG. 4 is a flowchart of one embodiment of a method for selecting menu items on the portable electronic device of FIG. 1.

FIG. 5 is a diagram illustrating an exemplary selection of menu items during the rotation of the portable electronic device of FIG. 1.

FIG. 6 is a diagram illustrating an exemplary application using digital numbers as input to the portable electronic device of FIG. 1.

### DETAILED DESCRIPTION OF CERTAIN INVENTIVE EMBODIMENTS

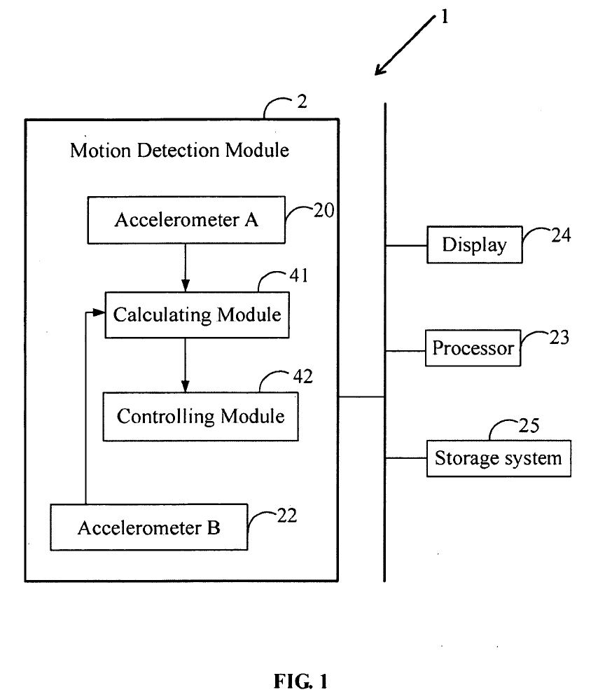

FIG. 1 is a block diagram of one embodiment of a portable electronic device 1. The portable electronic device 1 is for controlling menu items to rotate along with the portable electronic device 1 when the portable electronic device 1 has been rotated. The portable electronic device 1 may be a portable wireless device, such as a mobile telephone, a cordless telephone, a text messaging device, a pager, a radio, a portable navigation system, a portable music player, a portable video player, a portable multimedia device, a personal digital assistant (PDAs), a portable game, and the like.

The portable electronic device 1 includes a motion detection module 2, a processor 23, a display 24, and a storage system 25. The storage system 25 is used for storing applications of the portable electronic device 1 and other related data. The other related data includes movement, orientation, and or gesturing of the portable electronic device 1. The motion detection module 2 is configured for determining direction of movement of the portable electronic device 1 when orientation of the portable electronic device 1 has been changed. The motion detection module 2 is further configured for generating an input signal associated with the movement and for providing the input signal to an application in the portable electronic device 1 to initiate an operation performed by the application, wherein the input signal includes menu position information associated with a menu item of the application. The motion detecting module 2 is further configured for selecting a desired menu item according to the menu position. The processor 23 is coupled to the storage system 25 and the motion detection module 2. The processor 23 is used for executing the applications and the motion detection module 2. The display 24 is used for displaying the menu items in a manner to make obvious which menu item is currently selectable.

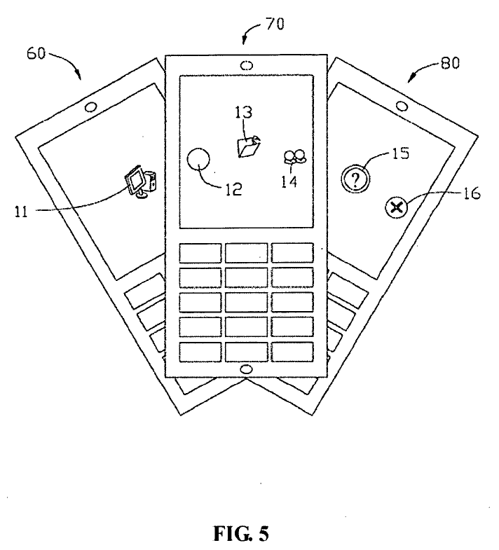

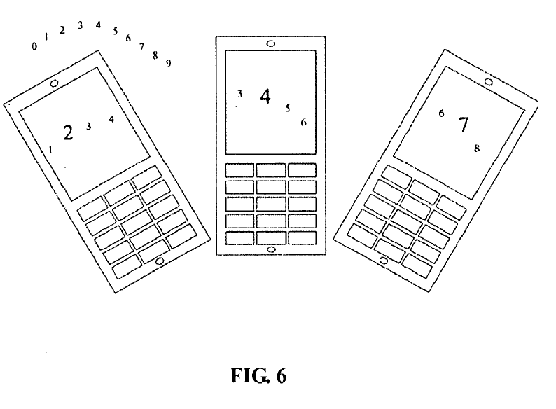

In one example, an application typically has a user interface having menu items with one or more items, any one of which may be selected by positioning a cursor at the desired item position in response to an input signal associated with a movement of the portable electronic device 1. As shown in FIG. 5 and FIG. 6, menu navigation is accomplished by a user gesturing the portable electronic device 1 left or right, which is detected as clockwise or counter-clockwise movement of the portable electronic device 1 causing the view of the menu to shift left or right correspondingly bring a different item to the top of an arc. In this embodiment, the menu items is displayed in an arc shape on the display 24, and the menu item appearing at the top of the arc is selectable.

In this embodiment, the motion detection module 2 includes a calculation module 41, a controlling module 42, and at least two accelerometers. A first accelerometer 20 is located at the top edge of the portable electronic device 1 and a second accelerometer 22 is located at the bottom edge of the portable electronic device 1.

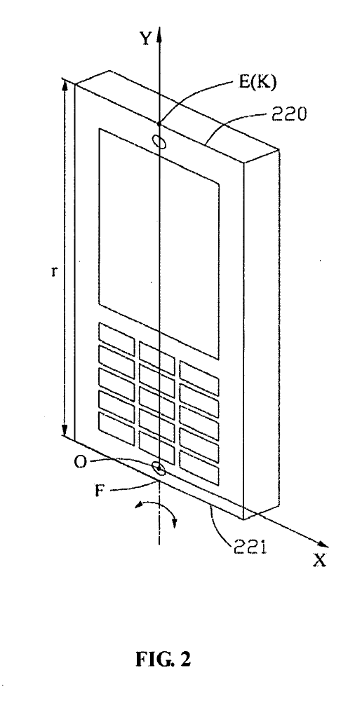

A simplified and representative exemplary procedure for operation of the portable electronic device 1 in accordance with various exemplary embodiments is shown in FIG. 2. FIG. 2 is a diagram illustrating an XY coordinate plane according to which a change in orientation of the portable electronic device 1 is determined. A front face of the portable electronic device 1 is set as the XY coordinate plane. A point centered at or near the bottom edge 221 of the portable electronic device 1 is set as the origin “O” of the XY coordinate plane. In this embodiment, while pressing a menu display key of the portable electronic device 1, the user gestures with the portable electronic device 1, causing the far edge 220 of the portable electronic device 1, as held by a user, to swivel more left or right than the near edge 221 of the portable electronic device 1. The movement is then interpreted as a clockwise or counter-clockwise motion of the portable electronic device 1 about the origin “O” of the XY coordinate plane. A line formed by connecting the point “E” at the top/far edge 220 of the portable electronic device 1 and the point “F” at the bottom/near edge 221 of the portable electronic device 1 is set as the Y-axis of the coordinate plane. Distance between the point “E” and the point “F” is labeled “r.”

The first and second accelerometers 20, 22 are used for detecting acceleration and direction of acceleration of the points “E” and “F” respectively. In other words, the accelerometers 20, 22 detect clockwise or counter-clockwise movement of the points “E” and “F” along the coordinate plane in relation to the origin “O.”

An application program interface (API) of an operating system of the portable electronic device 1 collects data from the accelerometers 20, 22. The data include the accelerations and the direction of the accelerations respectively of the points “E” and “F”. The data are stored into the storage system 25.

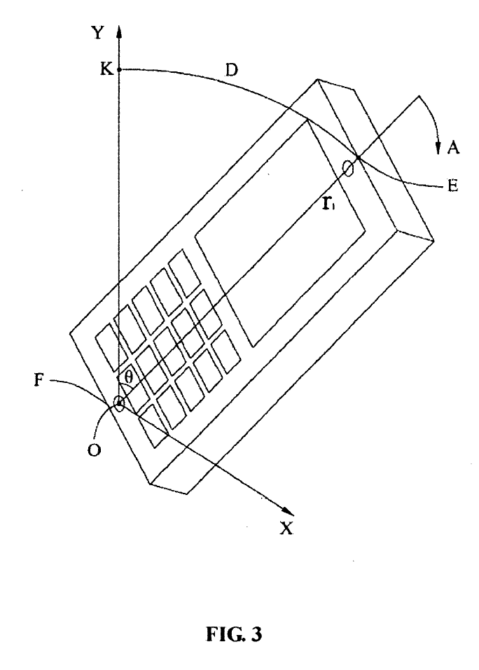

The calculation module 41 is configured for calculating a rotation angle “θ” of the portable electronic device 1 when rotated, while a menu display key of the portable electronic device 1 is pressed. Referring to FIG. 3, which shows the process of calculating the rotation angle “0” of the portable electronic device 1, the point “K” is on the Y-axis and is accorded with the point “E” when the portable electronic device 1 is not rotated as shown in FIG. 2. Distance between the origin “O” and the point “E” is labeled as “r₁.” Rotation path of the point “E” of the portable electronic device 1 is an arc, and the length of the rotation path is labeled as “D.”

The calculation module 41 calculates the rotation path “D” by a first equation: D=At²/2, wherein “A” represents acceleration of the point “E,” and “t” represents duration of acceleration of the point “E.”

The calculation module 41 calculates the distance “r₁” using a second equation: r₁=r*(A/(A+A₁)), wherein “r” represents the distance between the point “E” and point “F,” “A₁” represents acceleration of the point “F” and “r₁” represents the distance between the origin “O” and the point “E.”

The calculation module 41 further calculates the rotation angle “θ” using a third equation: θ=360*(D/(2*π*r₁)), wherein “D” represents the length of the rotation path.

The calculation module 41 sends the rotation angle “θ” to the controlling module 42. In order to select a desired menu item, the controlling module 42 is configured for controlling the menu items of the portable electronic device 1 to rotate the angle “θ” against the rotation direction of the portable electronic device 1.

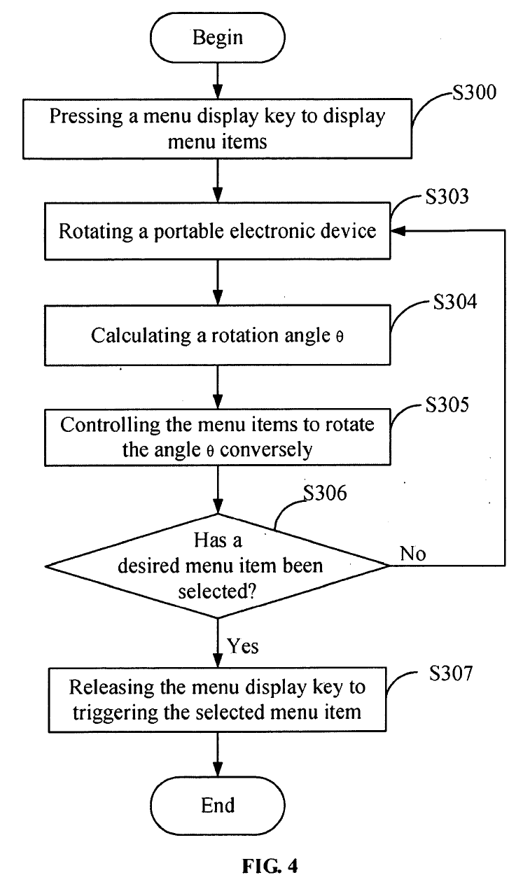

FIG. 4 is a flowchart of one embodiment of a method for selecting menu items on the portable electronic device 1. In block S300, a user presses a menu display key of the portable electronic device 1 to display menu items to the display 24 of the portable electronic device 1, in other words, the menu display key may be pressed by a user causing a pressed indication to be received by the portable electronic device 1. The display 24 displays the menu items in a manner to make obvious which menu item is currently selectable, such as in an arc shape in this embodiment. Accordingly, in the illustrated embodiment, the menu item appearing at the top of the arc is selectable. In other embodiments, the menu items may be displayed on the display 24 in other manners.

In block S303, the user rotates the portable electronic device 1 about the origin of the coordinate plane of FIG. 2 while pressing the menu display key of the portable electronic device 1, as shown in FIG. 2 and FIG. 3. The portable electronic device 1 may be rotated 30 degrees by a user causing a rotation indication to be received by the first and second accelerometer 20, 22. While the menu display key has been pressed and the movement data of the portable electronic device 1 are stored in the storage system 25 in response to the portable electronic device 1 being rotated. As mentioned above, after received the rotation indication, the first and second accelerometer 20, 22 detect clockwise or counter-clockwise movement of the points “E” and “F” along the coordinate plane in relation to the origin, respectively. An API of an operating system of the portable electronic device 1 collects data from the accelerometers 20, 22 and sends the data to the calculation module 41. The data include the accelerations and directions of the accelerations of the point “E” and “F.”

In block S304, the calculation module 41 calculates rotation angle “θ” of the portable electronic device 1 according to the movement data when rotated while the menu display key of the portable electronic device 1 is pressed. As shown in FIG. 2 and FIG. 3, in this embodiment, the calculation module 41 firstly calculates the rotation path “D” of the point “E” by using the first equation as illustrated above. Secondly, the calculation module 41 calculates the distance “r₁” by using the second equation as illustrated above. Thirdly, the calculation module 41 calculates the rotation angle “θ” by using the third equation as illustrated above. For example, the rotation angle “θ” may be 26 degrees. Then, the calculation module 41 sends the 26 degrees to the controlling module 42.

In block S305, the controlling module 42 controls the menu items of the portable electronic device 1 to rotate according to the 26 degrees and the rotation direction, in order to select a desired item of the menu items displayed on the display 24 of the portable electronic device 1. When the desired item is selected by the user, the selected item appears in a special color (e.g., a red or blue color) for distinguishing the selected item from other items of the menu items. As shown in FIG. 5, menu navigation is accomplished by the user rotating the portable electronic device 1 left or right, which is detected as clockwise or counter-clockwise movement of the portable electronic device 1 and causes the view of the menu to shift left or right correspondingly bring a different item to the top of the arc. Assuming the menu items of the portable electronic device 1 include six items: a first item 11, a second item 12, a third item 13, a fourth item 14, a fifth item 15, and a sixth item 16. The second item 12, the third item 13, and the fourth item 14 are displayed on the display 24 if the rotation angle “θ” of the portable electronic device 1 equals 0 degree or the portable electronic device 1 is located in a horizontal position 70. The calculation module 41 calculates a rotation angle “θ” of the portable electronic device 1 if the portable electronic device 1 rotates from the horizontal position 70 to a first position 80 in clockwise direction. For example, if the rotation angle “θ” is 26 degrees, the controlling module 42 controls the menu items of the portable electronic device 1 to rotate 26 degrees against the rotation direction of the portable electronic device 1, then the fourth item 14, the fifth item 15, and sixth item 16 are displayed on the display 24 of the portable electronic device 1. The calculation module 41 calculates a rotation angle “θ” of the portable electronic device 1 if the portable electronic device 1 rotations from the horizontal position 70 to a second position 60 in counterclockwise direction. For example, if the rotation angle “θ” is 30 degrees, the controlling module 42 controls the menu items of the portable electronic device 1 to rotate the 30 degrees against the rotation direction of the portable electronic device 1, then the first item 11 is displayed on the display 24 of the portable electronic device 1.

In block S306, the controlling module 42 may receive a determines indication to determine whether a desired menu item has been selected during the rotation of the portable electronic device 1. If a desired menu item has been selected, in block S307, the portable electronic device 1 triggers the selected menu item in response to the menu display key being released such that an operation corresponding to the selected menu item is invoked and executed. Otherwise, if a desired menu item has not been selected, the procedure returns to block S303.

FIG. 6 is a diagram illustrating an exemplary application using digital numbers as input to the portable electronic device 1. The user may use the same approach as the illustrated menu items selection when the user inputs the digital number to the portable electronic device 1. Firstly, the user presses a menu display key of the portable electronic device 1 to display the menu items in the digital form if the user needs to input the digital numbers. The display 24 of the portable electronic device 1 displays the digital menu items. Secondly, as shown in FIG. 2 and FIG. 3, the user rotates the portable electronic device 1, causing the far edge 220 of the portable electronic device 1, as held by the user, to swivel more left or right than the near edge 221 of the portable electronic device 1. The movement is then interpreted as a clockwise or counter-clockwise motion of the portable electronic device 1 about the origin of the coordinate plane. The first and second accelerometer 20, 22 detect the acceleration and direction of acceleration of the point “E” and the point “F” of the portable electronic device 1 respectively. The API of an operating system of the portable electronic device 1 collects data from the accelerometers 20, 22 and sends the data to the calculation module 41. Thirdly, the calculation module 41 calculates the rotation angle “θ” of the portable electronic device 1 by using the equations as illustrated above according to the data. The calculation module 41 sends the rotation angle “θ” to the controlling module 42. The controlling module 42 controls the number menu items to rotate according to the rotation angle “θ” and the rotation direction of the portable electronic device 1 in order to select a desired digital item from the digital menu items. Lastly, the user stops rotating the portable electronic device 1 and releases the menu display key to trigger a desired number item until the desired item appears in a special color for distinguishing from other items of the digital menu items.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device comprising:
a motion detection module configured for determining a direction of movement of the portable electronic device when orientation of the portable electronic device has been changed, generating an input signal associated with the movement, providing the input signal to an application of the portable electronic device to initiate an operation performed by the application, wherein the input signal comprises menu position information of a menu item of the application, and selecting a desired menu item according to the menu position; and
a storage system for storing the application and movement data of the portable electronic device.

2. The portable electronic device according to claim 1, wherein the motion detection module comprises:
at least two accelerometers having a first and second accelerometer for detecting an acceleration and a direction of the acceleration of a first point at a top edge of the portable electronic device and a second point at a bottom edge of the portable electronic device respectively;
a calculation module configured for calculating a rotation angle for rotating the portable electronic device when a menu display key of the portable electronic device is pressed according to the accelerations of the first point and second point;
a controlling module configured for controlling the portable electronic device to rotate in a rotation direction while pressing the menu display key, controlling the menu items of the portable electronic device to rotate the rotation angle against the rotation direction, and determining if a desired menu item of the menu items has been selected during the rotation of the portable electronic device.

3. The portable electronic device according to claim 2, wherein the first accelerometer is located at the top edge of the portable electronic device, and the second accelerometer is located at the bottom edge of the portable electronic device.

4. The portable electronic device according to claim 2, wherein a front face of the portable electronic device is set as an XY coordinate plane, a line formed by connecting the first point and the second point is set as the Y-axis of the XY coordinate plane, and a point centered at or near the bottom edge of the portable electronic device is set as the origin “O” of the XY coordinate plane.

5. The portable electronic device according to claim 2, wherein the calculation module is further configured for calculating a rotation path of the first point, the rotation path being equal to a half of a product of the acceleration of the first point and a square of the acceleration duration.

6. The portable electronic device according to claim 5, wherein the calculating module is further configured for calculating the rotation angle as follows: r₁=r*(A/(A+A₁)), and θ=360*(D/(2*π*r₁)), wherein: “r₁” represents a distance between the origin and the first point, “r” represents a distance between the first point and the second point, “A” represents the acceleration of the first point, “A₁” represents the acceleration of the second point, “D” represents the rotation path, and “0” represents the rotation angle.

7. A method for providing an input to an application of a portable electronic device, the method comprising:
determining a direction of movement of the portable electronic device, wherein the determining direction of movement comprises detecting an acceleration and a direction of the acceleration of the portable electronic device using at least two accelerometers when orientation of the portable electronic device has been changed;
generating an input signal associated with the movement, wherein the input signal comprises menu position information associated with a menu item of the application;
providing the input signal to the application to initiate an operation performed by the application;
selecting a desired menu item according to the menu position.

8. The method according to claim 7, wherein the movement of the portable electronic device comprises: gesturing the portable electronic device left or right.

9. A method for selecting menu items in a graphical user interface of a portable electronic device, the method comprising:
(a) receiving a pressed indication that a menu display key of the portable electronic device has been pressed;
(b) receiving a rotating indication that the portable electronic device has been rotated while the menu display key has been pressed;
(c) storing movement data of the portable electronic device in response to the portable electronic device being rotated;
(d) calculating a rotation angle of the portable electronic device according to the movement data;
(e) controlling all of the menu items to rotate the rotation angle against a rotation direction of the portable electronic device;
(f) receiving a determined indication to determine if a desired menu item has been selected during the rotation of the portable electronic device; and
(g) triggering the desired menu item in response to the menu display key being released if the desired menu item has been selected, or returning to block (b) if the desired menu item has not been selected.

10. The method according to claim 9, wherein the block (d) comprises:
detecting an acceleration of a first point at a top edge of the portable electronic device; and
detecting an acceleration of a second point at a bottom edge of the portable electronic device.

11. The method according to claim 10, wherein the block (d) further comprises:
calculating a rotation path of the first point, wherein the length of the rotation path is equal to a half of a product of the acceleration of the first point and a square of an acceleration duration.

12. The method according to claim 11, wherein the block (d) further comprises:
calculating the rotation angle as follows: r₁=r*(A/(A+A₁)), and θ=360*(D/(2*π*r₁)), wherein: “r₁” represents a distance between a rotation center and the first point, “r” represents a distance between the first point and the second point, “A” represents the acceleration of the first point, “A₁” represents the acceleration of the second point, “D” represents the length of the rotation path, and “θ” represents the rotation angle.

13. A storage system medium having stored thereon instructions that, when executed by a portable electronic device, causing the portable electronic device to perform a method for selecting menu items of the portable electronic device, the method comprising:
(a) receiving indication that a menu display key of the portable electronic device has been pressed;
(b) receiving a rotating indication that the portable electronic device has been rotated while the menu display key has been pressed;
(c) storing movement data of the portable electronic device in response to the portable electronic device being rotated;
(d) calculating a rotation angle of the portable electronic device according to the movement data;
(e) controlling all of the menu items to rotate the rotation angle against a rotation direction of the portable electronic device;
(f) receiving a determined indication to determine if a desired menu item has been selected during the rotation of the portable electronic device; and
(g) triggering the desired menu item in response to the menu display key being released if the desired menu item has been selected, or returning to block (b) if the desired menu item has not been selected.

14. The medium according to claim 13, wherein the block (d) comprises:
detecting an acceleration of a first point at a top edge of the portable electronic device; and
detecting an acceleration of a second point at a bottom edge of the portable electronic device.

15. The medium according to claim 14, wherein the block (d) further comprises:
calculating a rotation path of the first point, wherein a length of the rotation path being equal to a half of a product of the acceleration of the first point and a square of an acceleration duration.

16. The medium according to claim 15, wherein the block (d) further comprises:
calculating the rotation angle as follows: r₁=r*(A/(A+A₁)), and θ=360*(D/(2*π*r₁)), wherein: “r₁” represents a distance between a rotation center and the first point, and “r” represents a distance between the first point and the second point, “A” represents the acceleration of the first point, “A₁” represents the acceleration of the second point, “D” represents the length of the rotation path, and “0” represents the rotation angle.
